(19) United States
(12) Patent Application Publication
(10) Pub. No.: US 2017/0220234 A1
(43) Pub. Date: Aug. 3, 2017

(54) IMPLICITLY GROUPING ANNOTATIONS WITH A DOCUMENT

(71) Applicant: Hewlett-Packard Development Company, LP, Houston, TX (US)

(72) Inventors: Jordi Morillo Peres, Barcelona (ES); Lynna Wuhyun Chung, Palo Alto, CA (US); Ruth Ann Lim, Santa Clara, CA (US)

(21) Appl. No.: 15/500,552

(22) PCT Filed: Jul. 31, 2014
(86) PCT No.: PCT/US2014/049224

§ 371 Date: Jan. 31, 2017

(51) Int. Cl. G06F 3/0484; G06F 17/24; G06F 3/0488; G06F 17/30; G06F 3/042; G06T 11/60

(52) U.S. Cl. CPC G06F 3/04845; G06F 3/0425; G06T 11/60; G06F 3/04842; G06F 3/0488; G06F 17/30268; G06F 17/241; G06T 2210/12

(57) ABSTRACT

A method of implicitly grouping annotations with a document includes with a projection device, projecting an image of a document onto a touch sensitive pad. The method further includes receiving a number of user-input annotations to the document, and with a processor, implicitly associating the annotations with the document without receiving selection of an annotation grouping mode from a user.

### BACKGROUND

The field of document creation and annotation is an ever-growing technological field due to the ever-increasing use of computing devices and electronic document sharing. In document production in which a user may annotate an existing document such as a form document, the user may struggle with the ability to manage a number of annotations made to the document. Thus, a usability problem exists because a user who wishes to annotate a digital image using ink or text, for example, would need to perform additional steps to explicitly group the ink and text objects with the image. If the user does not explicitly group the annotations, then the annotations will not move with or be treated as a part of the image when the user manipulates the image.

### BRIEF DESCRIPTION OF THE DRAWINGS

The accompanying drawings illustrate venous examples of the principles described'herein and,are a part of the specification. The illustrated examples are given merely for illustration, and do not limit the scope of the claims.

FIG. 1 is a perspective view of a system for implicitly grouping annotations with an image, according to one example of the principles described herein.

FIG. 2 is a block diagram of a system for implicitly grouping annotations with an image of a document, according to one example of the principles described herein.

FIG. 3 is a schematic view of the system of FIG. 1 depicting a workspace on a touch-sensitive pad for use in annotating, an image of a document, according to one example of the principles described herein,

FIGS. 4 through 6 are schematic views of the system of FIG. 1 in use to annotate an image of a document with an ink tool, according to one example of the principles described herein.

FIGS. 7 through 12 are schematic views of the system of FIG. 1 in use to annotate an image of a document with a type tool, according to one example of the principles described herein.

FIG. 13 is a flowchart showing a method of annotating an image, according to one example of the principles described herein.

Throughout the drawings, identical reference numbers designate similar, but not necessarily identical, elements.

### DETAILED DESCRIPTION

The present systems and methods provide as default an implicit grouping of annotations made to an image projected onto a touch-sensitive pad. The system may include a first interface such as a vertical touch screen, a horizontal interface such as the touch-sensitive pad, an image capture device, and an image projection device. The system may capture an image of a document displayed on the touch-sensitive pad. The user may remove the document from the touch-sensitive pad, and the system projects an exact replica of the document on the touch-sensitive pad.

The user may then annotate the projected image of the document by adding ink objects, text objects, imported digital objects, or combinations thereof. These annotations are implicitly grouped together by default each time the user adds a new annotation. In one example, the user may ungroup the annotations. The ungrouped annotations, whether ink or text annotations, may remain as part of the document and are not deleted. In this manner, the user may move the annotations to different portions of the document as separate items. The annotations may also be regrouped to create a new instance of the group. In this regrouping, the newly-created group is created manually instead of implicitly.

Thus, the system groups a number of annotations, in which the grouping is treated by the processor as a compound object. Once an annotated document is obtained, the annotated document may be stored in memory, output to an output device such as a display device or a printing device, or transmitted to another computing device.

As used in the present specification and in the appended claims, the term “implicit” or similar language is meant to be understood broadly as an action performed by a computing device that requires no explicit designation or selection from a user. In the examples herein, a number of annotations are implicitly grouped such that the user is not required to explicitly designate or select the annotations as a group. Although, in one example, a user may explicitly ungroup, group, or modify a group of annotations, the systems and methods described herein group the annotations implicitly and be default.

Further, as used in the present specification and in the appended claims, the term “a number of” or similar language is meant to be understood broadly as any positive number comprising 1 to infinity; zero not being a number, but the absence of a number.

in the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

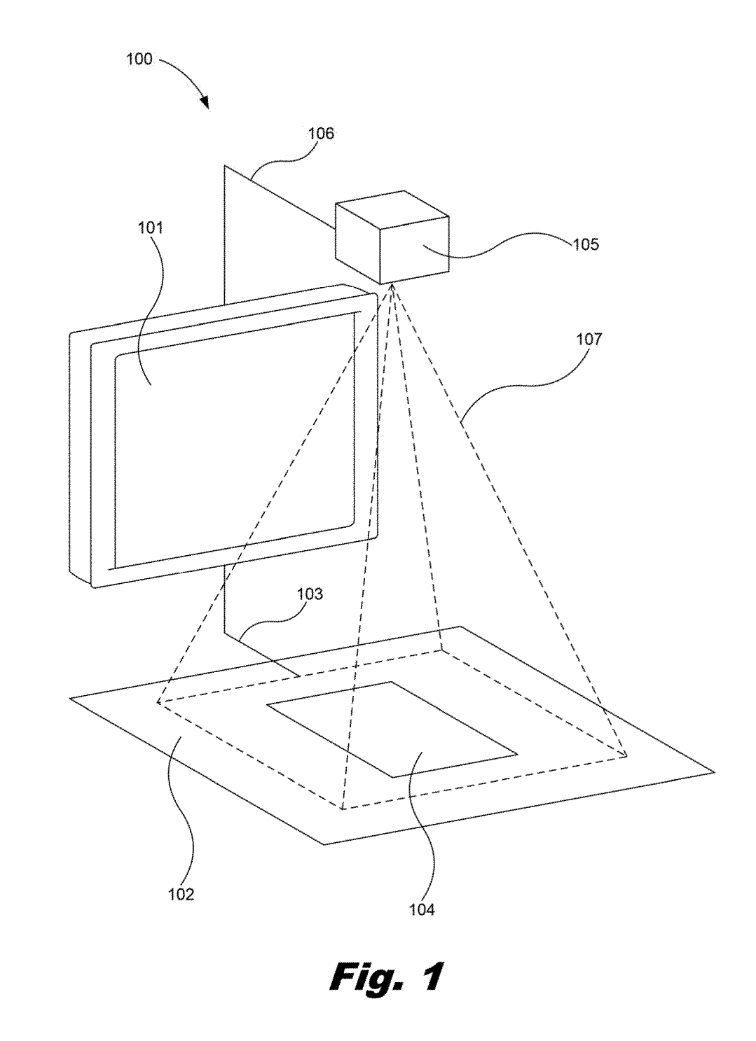

Turning now to the figures, FIG. 1 is a perspective view of a system (100) for implicitly grouping annotations with an image, according to one example of the principles described herein. The system (100) comprises a computing device (101), a touch-sensitive pad (102), and an imaging device (105). The computing device (101) may be a desktop computer, a laptop computer, a mobile device such as a tablet device or a mobile phone device, a personal digital assistant (PDA), or an all-in-one computing device with a touch sensitive screen, among other computing device types.

The touch-sensitive pad (102) is communicatively coupled to the computing device (101) via a first communication link (103). In this manner, the touch-sensitive pad (102) and computing device (101) may communicate, for example, data representing commands entered by a user. This data may include data representing a number of annotations made to an image of a document (104) projected onto the touch-sensitive pad (102), data representing a number of commands entered by the user using the touch-sensitive pad (102), or data representing a request for data from the computing device (101), among other types of data. Further, the computing device (101) may communicate for example, data associated with the image of the document (104), commands entered by a user on the computing device (101), or data representing a request for data from the touch-sensitive pad (102), among other types of data.

The imaging device (105) may comprise any device or combination of devices that are capable of capturing the image of the document (104) such as a document (104) placed on the touch-sensitive pad (102), and is capable of projecting an image of the document (104) onto the touch-sensitive pad (102). Thus, the imaging device (105) may comprise an image capture device such as a camera or video capture device, and a projection device such as a digital image projector. The imaging device (105) is communicatively coupled to the computing device (101) via a second communication link. In one example, the imaging device (105) and the computing device (101) may communicate, for example, data representing images of objects captured by the imaging device (105), images of objects projected by the imaging device (105), data representing a number of commands entered by the user using the touch-sensitive pad (102) or computing device (101) to control the imaging device (105), or data representing a request for data from the imaging device (105), among other types of data.

The first (103) and second (106) communication links may be any type of wired or wireless communication link. As to wire-based communication examples, the first (103) and second (106) communication links may comprise Ethernet cables, fiber optic cables, universal serial bus (USB) cables, or other wired communication types and protocols as identified by the Institute of Electrical and Electronics Engineers (IEEE). As to wireless-based communication examples, the first (103) and second (106) communication links may utilize any type of wireless protocol including BLUETOOTH communication protocols developed by the Bluetooth Special Interest Group, Wi-Fi wireless communication protocols developed by the Wi-Fi Alliance, near field communication protocols, infrared communication protocols, or other wireless communication types and protocols as identified by the Institute of Electrical and Electronics Engineers (IEEE).

In one example, the system (100) may use the it device (105) to capture an, image, of a document (104) or other object placed on the touch-sensitive pad (102), and project an image of the document (104) onto the touch-sensitive pad (102) in approximately the same orientation, size, and lateral position along the surface of the touch-sensitive pad (102). In this manner, a user may instruct the system (100) to capture an image of the document (104). The user may remove the document (104) from the touch-sensitive pad (102), and instruct the system to project an image of the document (104) onto the touch-sensitive pad (102). Element 107 of FIG. 1 depicts a field of image capture and image projection provided by the imaging device (105).

Thereafter, a user may add a number of annotations to the projected image of the document (104) by interacting with the touch-sensitive pad (102) including adding, textual or graphical elements. The system (100) may then store the document and its associated annotations in a data storage device. In one example, the document, the document's associated annotations, or combinations thereof may be output to an output device such as a display device of the computing device (101) or a printing device, or an electronic copy of the document, the document's associated annotations, or combinations thereof may be transmitted to another computing device.

In one example, the computing device (101) is an all-in-one computing device. An all-in-one computing device is defined herein as a computer integrates the system's internal components including, for, example, the motherboard, the central processing unit, and memory devices, among other components of a computing device into the same housing as a display device utilized by the computing device. In one example, the all-in-one computing device (101) comprises a display with touch screen capabilities. Thus, in one example, the all-in-one computing device (101) is, for example, a TOUCHSMART computing device or a PAVILION computing device, both produced and distributed by Hewlett-Packard Company, or any other all-in-one or all-in-one touch screen computing device produced and distributed by Hewlett-Packard Company.

The touch-sensitive pad (102) may comprise a resistive touchscreen panel, a capacitive touchscreen panel, a surface acoustic wave touchscreen panel, infrared touchscreen panel, or an optical touchscreen panel, among other types of touchscreen panels. The user may select a number of commands or options displayed on the touch-sensitive pad (102) to control the computing device (101) and the imaging device (105). The user may also make annotations to a document (104) projected onto the touch-sensitive pad (102), or perform other functions in connection with the control of any element of the system (100).

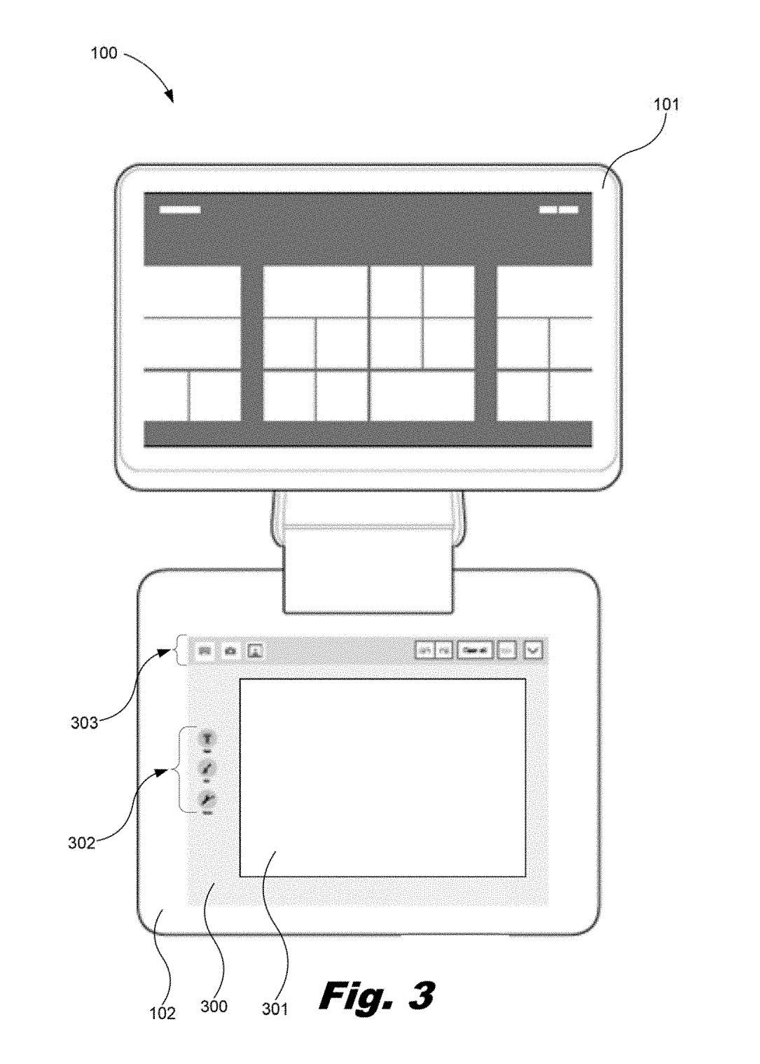

In one example, the imaging device (105) displays an interface onto the touch-sensitive pad (102) in addition to the document (104) as depicted in, for example, FIGS. 3 through 11. The interface allows the user to make selections of a number of commands while annotating the document. These commands may include commands requesting the document to be saved with or without annotations, commands requesting a document (104) be projected onto the touch-sensitive pad (102), commands requesting activation of a number of annotation tools, or commands requesting that an optical character recognition (OCR) process be performed on the digital representation of the projected image of the document (104), among many other commands. The computing device (101) and touch-sensitive pad (102) are able to map the location of the user interface and its number of selectable commands such that the selection of the selectable commands by a user via the touch-sensitive pad (102) will result in the functionality of those respective commands being understood by the computing device (101) and touch-sensitive pad (102). In this manner, annotations made by a user on the touch-sensitive pad (102) may be understood by the computing device (101), and those annotations may be processed according to the methods described herein.

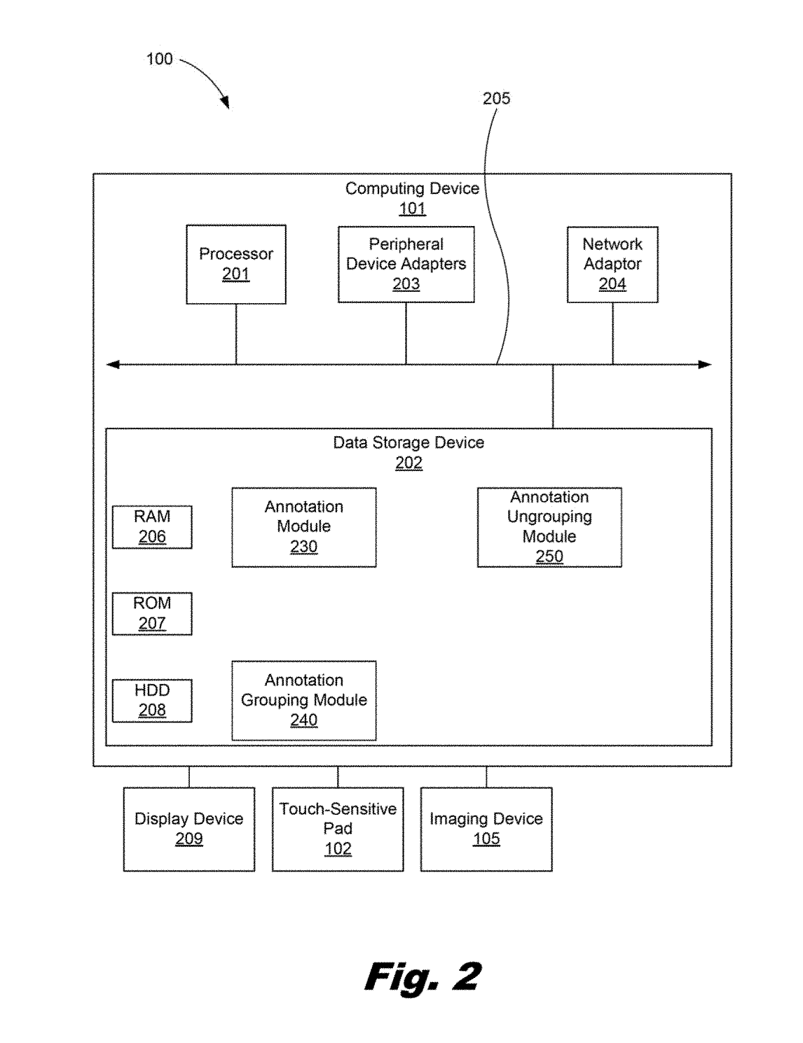

FIG. 2 is a block diagram of the system (100) for implicitly grouping annotations with an image of the document (104), according to one example of the principles described herein. The system (100) may comprise the computing device (101), the touch-sensitive pad (102), and the imaging device (105) as described above.

The computing device (101) may be implemented in an electronic device. Examples of electronic devices include servers, desktop computers, laptop computers, personal digital assistants (PDAs), mobile devices, smartphones, gaming systems, and tablets, among other electronic devices.

The computing device (101) may be utilized in any data processing scenario including, stand-alone hardware, mobile applications, through a computing network, or combinations thereof. Further, the computing device (101) may be used in a computing network, a public cloud network, a private cloud network, a hybrid cloud network, other forms of networks, or combinations thereof. In one example, the methods provided by the computing device (101) are provided as a service over a network by, for example, a third party. In this example, the service may comprise, for example, the following: a Software as a Service (SaaS) hosting a number of applications; a Platform as a Service (PaaS) hosting a computing platform comprising, for example, operating systems, hardware, and storage, among others; an Infrastructure as a Service (Iaas) hosting equipment such as, for example, servers, storage components, network, and components, among others; application program interface (API) as a service (APIaaS), other forms of network services, or combinations thereof.

The present systems may be implemented on one or multiple hardware platforms, in which the modules in the system can be executed on one or across multiple platforms. Such modules can run on various forms of cloud technologies and hybrid cloud technologies or offered as a SaaS 83960

(Software as a service) that can be implemented on or off the cloud. In another example, the methods provided by the computing device (101) are executed by a local administrator.

To achieve its desired functionality, the computing device (101) comprises various hardware components. Among these hardware components may be a number of processors (201), a number of data storage devices (202), a number of peripheral device adapters (203), and a number of network adapters (204). These hardware components may be interconnected through the use of a number of busses and/or network connections. In one example, the processor (201), data storage device (202), peripheral device adapters (203), and a network adapter (204) may be communicatively coupled via a bus (205).

The processor (201) may include the hardware architecture to retrieve executable code from the data storage device (202) and execute the executable code. The executable code may, when executed by the processor (201), cause the processor (201) to implement at least the functionality of capturing an image of a document (104), projecting the image of the document (104) onto the touch-sensitive pad (102), providing annotation tools to annotate the document (104), processing annotations made to the document (104) by a user, and storing the annotations according to the methods of the present specification described herein. In the course of executing code, the processor (201) may receive input from and provide output to a number of the remaining hardware units.

The data storage device (202) may store data such as executable program code that is executed by the processor (201) or other processing device. As will be discussed, the data storage device (202) may specifically store computer code representing a number of applications that the processor (201) executes to implement at least the functionality described herein.

The data storage device (202) may include various types of memory modules, including volatile and nonvolatile memory. For example, the data storage device (202) of the present example includes Random Access Memory (RAM) (206), Read Only Memory (ROM) (207), and Hard Disk Drive (HDD) memory (208). Many other types of memory may also be utilized and the present specification contemplates the use of many varying type(s) of memory in the data storage device (202) as may suit a particular application of the principles described herein. In certain examples, different types of memory in the data storage device (202) may be used for different data storage needs. For example, in certain examples the processor (201) may boot from Read Only Memory (ROM) (207), maintain nonvolatile storage in the Hard Disk Drive (HDD) memory (20$), and execute program code stored in Random Access Memory (RAM) (206).

Generally, the data storage device (202) may comprise, a computer readable medium, a computer readable storage medium, or a non-transitory computer readable medium, among others. For example, the data storage device (202) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters (203, 204) in the computing device (101) enable the processor (201) to interface with various other hardware elements, external and internal to the computing device (101). For example, the peripheral device adapters (203) may provide an interface to input/output devices, such as, for example, display device (209), a mouse, or a keyboard. The peripheral device adapters (203) may also provide access to other external devices such as an external storage device, a number of network devices such as, for example, servers, switches, and routers, client devices, other types of computing devices, and combinations thereof.

The display device (209) may be provided to allow a user of the computing device (101) to interact with and implement the functionality of the computing device (101). In one example, the display device (209) of the computing device (101) may be a touch screen display comprising a resistive touchscreen panel, a capacitive touchscreen panel, a surface acoustic wave touchscreen panel, infrared touchscreen panel, or an optical touchscreen panel, among other types of touchscreen panels. In another example, the display device (209) of the computing device (101) may be a cathode ray tube (CRT) display, a light-emitting diode (LED) display, an electroluminescent display (ELD), a plasma display panel (PDP), a liquid crystal display (LCD), or other forms of display devices.

The peripheral device adapters (203) may also create an interface between the processor (201) and the display device (209), a printer, or other media output devices. The network adapter (204) may provide an interface to other computing devices within, for example, a network, thereby enabling the transmission of data between the computing device (101) and other devices located within the network.

The computing device (101) may, when executed by the processor (201), display the number of graphical user interfaces (GUIs) on the display device (209) associated with the executable program code representing the number of applications stored on the data storage device (202). The GUIs may include aspects of the executable code including executable code that provides for capturing an image of a document (104), projecting the image of the document (104) onto the touch-sensitive pad (102), providing annotation tools to annotate the document (104), processing annotations made to the document (104) by a user, and storing the annotations according to the methods of the present specification described herein. The GUIs may display, for example, user-interactive icons, buttons, tools, or other interfaces that bring about the functionality of the systems and methods described herein. Additionally, via making a number of interactive gestures on the GUIs of the display device (209), a user may bring about the functionality of the systems'and methods described herein. Examples of display devices (209) include a computer screen, a laptop screen, a mobile device screen, a personal digital assistant (PDA) screen, and a tablet screen, among other display devices (209). Examples of the GUIs displayed on the display device (209), will be described in more detail below.

As described above, the touch-sensitive pad (102) and the imaging device (105) are communicatively coupled to the computing device (101) to transmit data among these devices. In this manner, the system (100) may obtain data associated with a number of annotations made by a user to an image of a document (104) displayed on the touch-sensitive pad (102), and implicitly group the annotations with the image of the document (104).

The computing device (101) further comprises a number of modules used in the implementation of the functionality of the systems and methods described herein. The various modules within the computing device (101) comprise executable program code that may be executed, separately. In this example, the various modules may be stored as separate computer program products. In another example, the various modules within the computing device (101) may be combined within a number of computer program products; each computer program product comprising a number of the modules.

The computing device (101) may include an annotation module (230) to, when executed by the processor (201), annotate a document according to selections and interactions made by a user with the touch-sensitive pad (102). Annotations may include text annotations, ink annotations, and image annotations as described above.

The computing device (101) may include an annotation grouping module (240) to, when executed by the processor (201), group annotations made to an electronic document projected onto the touch-sensitive pad (102) according to a number of rules. In one example, the annotation grouping module (240) implicitly groups individual annotations made to a document even though the annotations are considered by the system (100) as independent objects. In another example, the annotation grouping module (240) includes executable code that defines a number of business rules to determine when annotations should be implicitly grouped versus treated as independent annotations.

The computing device (101) may include an annotation ungrouping module (250) to, when executed by the processor (201), receive a selection of a number of individual annotations which the user indicates should be ungrouped. This ungrouping option allows the user to select individual annotations for deletion, moving, rotation, or other form of editing. As described above, the annotation grouping module (240) implicitly groups individual annotations made to a document. However, since the canvas grouping may also be used for manual or explicit user grouping of objects, the user may use a number of grouping controls to edit a group of annotations. Editing the group of annotations includes adding or removing objects from the group, ungrouping all of the objects, repositioning grouped annotations relative to each other, among other annotation group editing functions. In this manner, it is possible for the user to obtain the underlying document without annotations by deleting all the annotations. Further, the user may retain one or more annotations while deleting a number of other annotations. Thus, the ungrouped annotations, whether ink or text annotations, may remain as part of the document and may not be deleted. In this manner, the user may move the annotations to different portions of the document as separate items. The annotations may also be regrouped to create a new instance of the group. In this regrouping, the newly-created group is created manually instead of implicitly.

FIG. 3 is a schematic view of the system (100) of FIG. 1 depicting a workspace (300) on a touch-sensitive pad (102) for use in annotating an image of a document (104), according to one example of the principles described herein. As depicted in FIG. 3, the touch-sensitive pad (1021 may have a workspace (300) with which the use interacts with to annotate an image of the document (104), for example. The workspace (300) may comprise a document display space (301), a number of annotation tools (302), and a menu (303). The document display space (301) is used as a space in which the user places a document (104) for image capture by the imaging device (105) and in which the system (100) displays an image of the document (104). Thus, it is in the document display space (301) in which the user may annotate the displayed image of the document (104).

The annotation tools may be selected by a user by touching the portion of the touch-sensitive pad (102) on which a corresponding icon is located. For example, the icons may indicate a tool used for annotating the image of the document (104) in some way including, for example, adding text objects, adding ink objects, and adding digital objects imported from another source, among other types of annotation objects.

The menu (303) may comprise a number of selectable menu options that provide additional functionality such as, for example, document saving options, document printing options, image importing options, document viewing options, arid annotation grouping options, among other types of menu options. As to the annotation grouping options, a user may be given to the option to ungroup a number of annotations from other annotations and from the underlying document (104) as will be described in more detail below. However, the present systems and methods implicitly group annotations together and with the underlying document (104) such that the grouped annotations are placed on a separate virtual canvas. This implementation of grouping allows for the use of the text objects, ink objects, and digital objects imported from another source as presented herein, and provides the ability to move all of the grouped objects as a unit by moving the canvas. In one example, the size of this canvas may be defined to be the size of the smallest rectangular bounding box that includes all of the objects in the group.

The canvas may be defined by a number of user interface and graphical user interface libraries or frameworks. These libraries or frameworks may include, for example, the WINDOWS PRESENTATION FOUNDATION (WPF) runtime libraries developed and distributed by Microsoft Corporation, the QT (pronounced /‘kju:t/ of “cute”) runtime library developed and distributed by Digia and the Qt Project, WINDOWS FORMS (WINFORMS) graphical application programming interface (API) developed and distributed by Microsoft Corporation, or JAVA RUNTIME ENVIRONMENT developed and distributed by Oracle America, Inc. The annotations are grouped and placed in the same canvas, and the canvas is added to the collection of objects in the document.

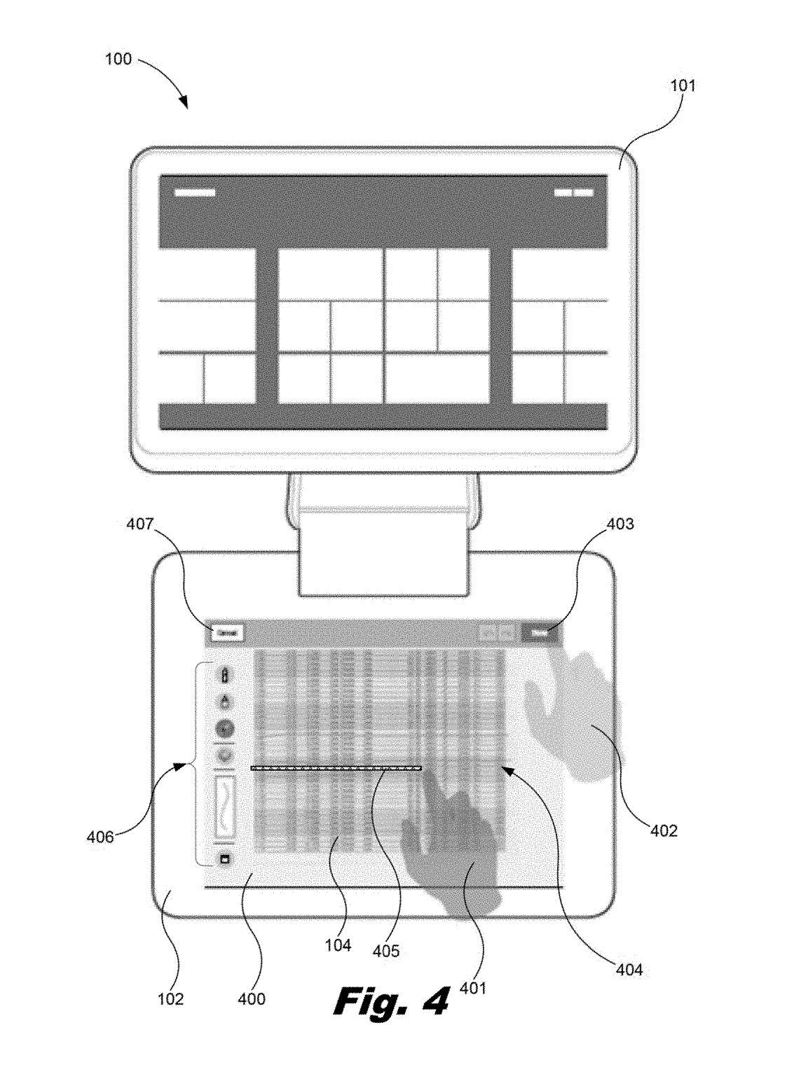

FIGS. 4 through 6 are schematic views of the system (100) of FIG. 1 in use to annotate an image of the document (104) with an ink tool (, according to one example of the principles described herein. As depicted in FIG. 4, the system (100) has captured an image of a document (104) and the document is selected by a user and displayed in an annotation workspace (400). In the example of FIG. 4, the document (104) is a spreadsheet document created by a spreadsheet application such as, for example, EXCEL spreadsheet application developed and distributed by Microsoft Corporation. The ghost hands (401, 402) depict a user's interaction with the touch-sensitive pad (102) in creating an ink annotation. In the example of FIG. 4, the user is highlighting (405) a horizontal row entry (404) within the spreadsheet document as depicted with ghost hand 401. In one example, the user may have selected a highlight or ink tool among the annotation tools (302) of the workspace (300).

As depicted in FIG. 4, a number of ink annotation tools (406) may be displayed to the user to apply different types of ink annotations including highlighting, line drawing, or paint brushing, among other types of ink annotations. Once the user is finished annotating, the user may select a “Done” button (403) to exit the annotation mode as indicated by ghost hand (402). Alternatively, in order to cancel the annotation and clear that highlighting (405) or other ink annotation instance from the document (104), and return to the document (104), the user may select a “Cancel” button (407).

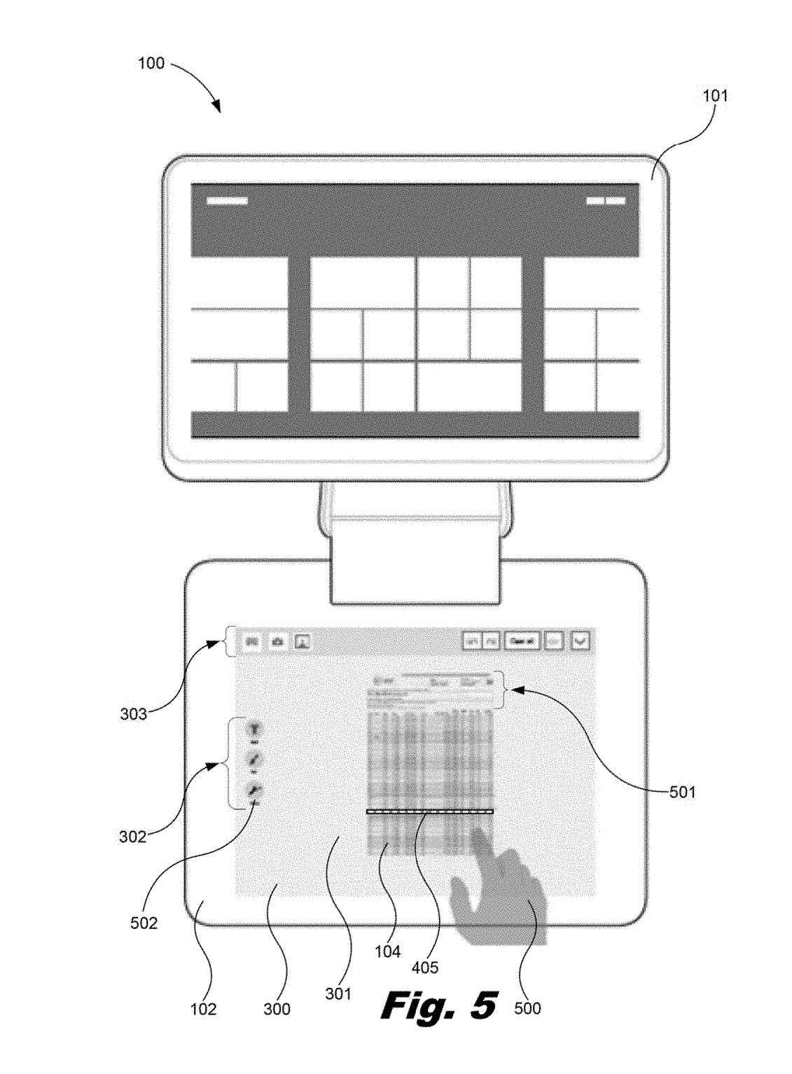

In FIG. 5, the user may select the document (104) by touching the document (104) within the document display space (301) of the workspace (300) as the ghost hand (500) is depicted. FIG. 5 also depicts the addition of a digital object (501) imported into the document and appended thereto. A user may select an import button (502), select a digital object from a file stored on the computing device (101) or other source, and select a portion of the document (104) to append the digital object (501). In this manner, the highlighting (405) and digital object (501) are recognized as being on the above-described canvas and are treated as implicitly grouped. A user may further add text annotations to the document (104) which the system (100) will implicitly add to the canvas. Text annotations will be described in mare detail below. In one example, the digital object (501) added to the document (104) may be, for example, a notary signature block, a watermark, an image or other form of non-text or non-ink element. In another example, the digital object (501) added to the document (104) may be another document. In this example, the added document may be appended before or after the document (104). Thus, grouping of the annotations may include implicitly grouping documents along with the ink annotations and the text annotations.

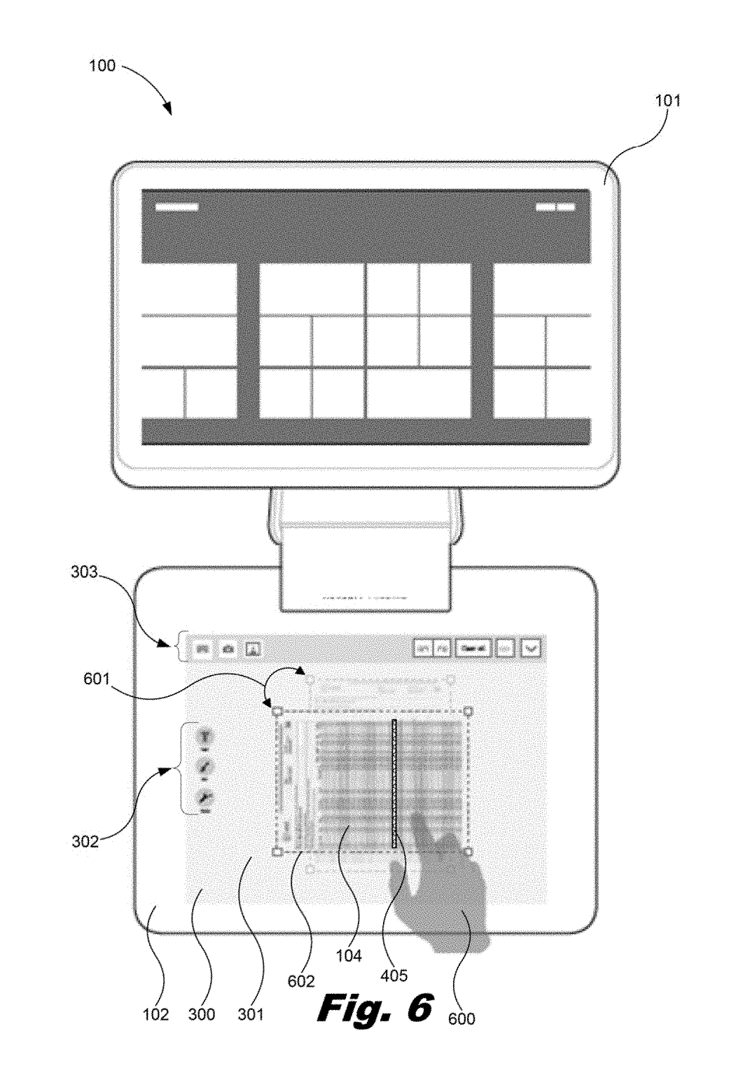

As depicted in FIG. 6, the ink layer created by the highlighting (405) in FIG. 4 and the document (104) are implicitly grouped. As described above, the size of this canvas may be defined to be the size of the smallest rectangular bounding box that includes all of the objects in the group. The bounding box (602) is depicted in FIG. 6 using a dashed-line box around the document (104) and the highlighting (405). If a user annotates outside the rectangular bounding box (602) then the area of the rectangular bounding box (602) is enlarged to include that additional annotation.

In this manner, the highlighting (405) and the document (104) may be rotated, resized, or moved together as a single unit. Rotation of the implicitly grouped highlighting (405) and document (104) is depicted in FIG. 6 by arrow 601. While having the implicitly grouped highlighting (405) and document (104) selected, the user may select an annotation tools (302) to edit the highlighting (405), for example.

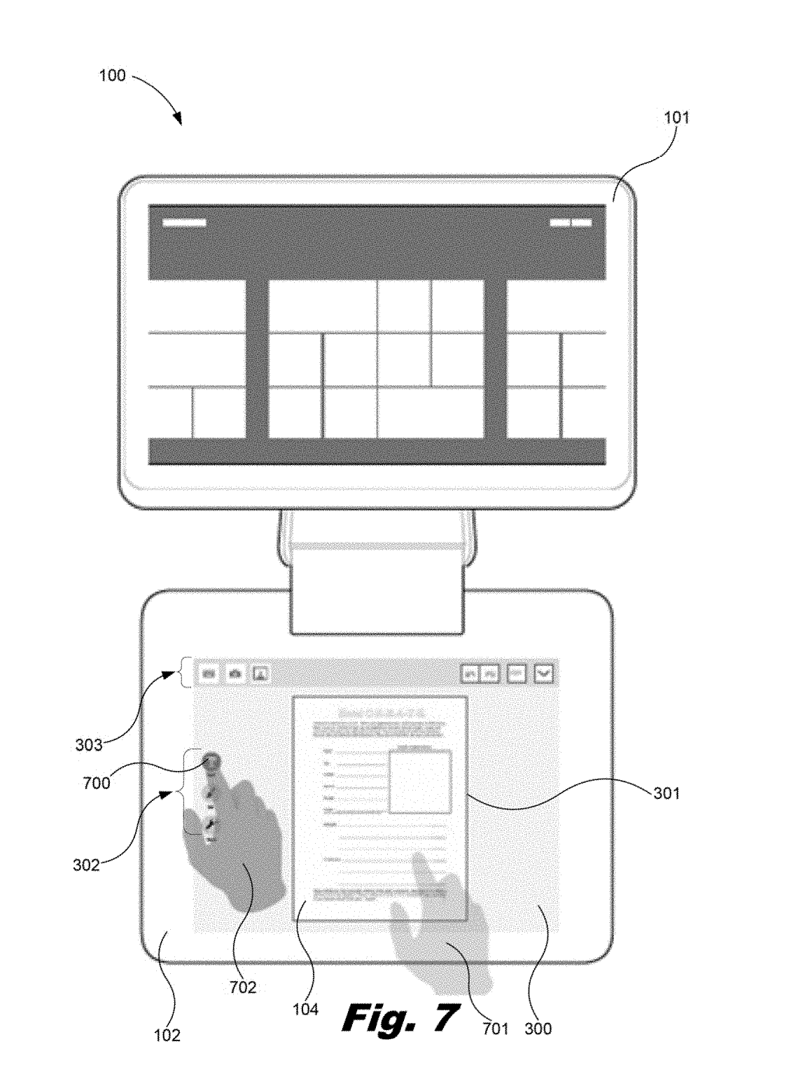

FIGS. 7 through 12 are schematic views of the system (100) of FIG. 1 in use to annotate an image of the document (104) with a type tool, according to one example of the principles described herein. As depicted in FIG. 7, a user may select the document (104) as depicted by ghost hand (701). In order to create type objects within the document (104), the user may select the type tool (700) as depicted by ghost hand (702). Once the type tool (700) is selected, the workspace (300) may switch to an edit mode in which a keyboard (800) is displayed.

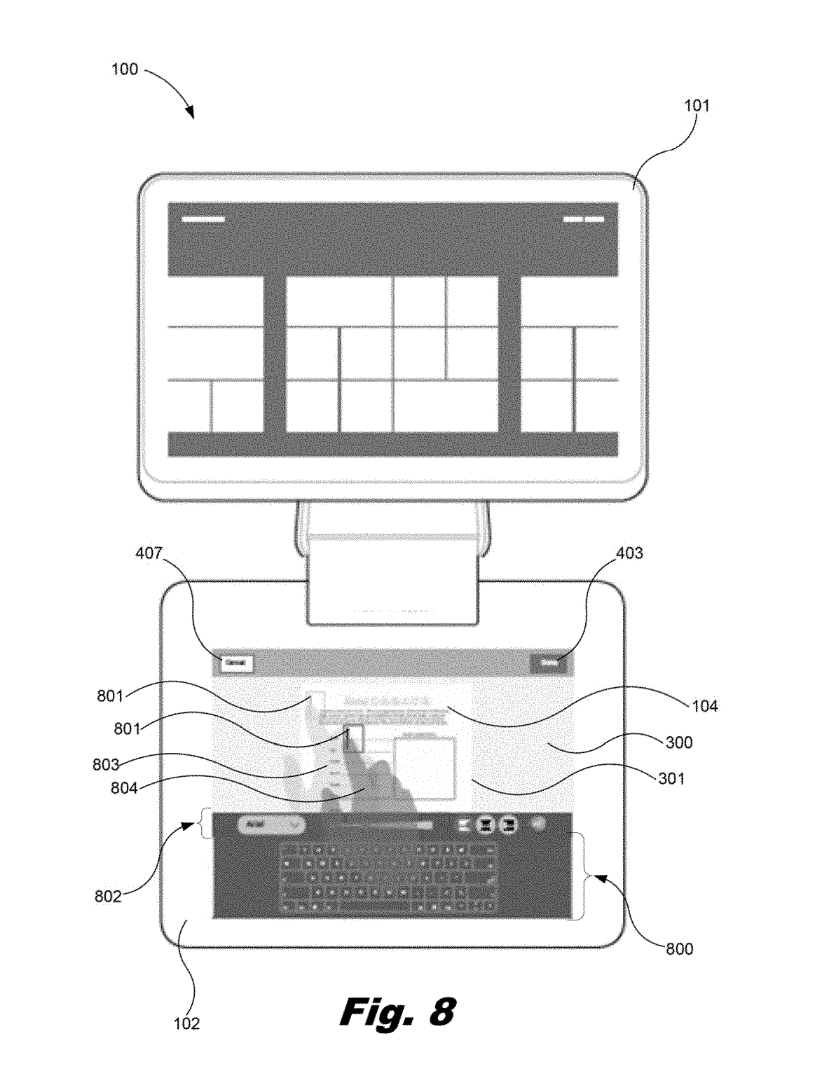

A text box (801) appears to allow the user to type text into the box as an annotation. In one example, the text box (801) may appear at a default position such as, for example, the upper left corner of the document (104) as depicted in FIG. 8. In another example, the text box (801) appears at a location corresponding to an area of the touch-sensitive pad (102) last touched or next touched by the user. The user may move the text box (801) to a position on the document where he or she wants it to be placed as depicted by ghost hands 803 and 804. This allows the user to fill in desired portions of the document with text such as in the example of FIG. 8 where a fill in form is presented.

A set of text controls (802) may be located above the keyboard (800). The text controls (802) provide for a user to change text styles, fonts, sizes, justification within the text box (801), alignment within the text box (801), line spacing, or other characteristics of the text entered into the text box (801). In FIG. 8, only the selected text box (801) is shown. However, this single text box (801) cannot be moved, sized, rotated, or otherwise edited, at this phase of the annotation because the user has not selected the “Done” button (403).

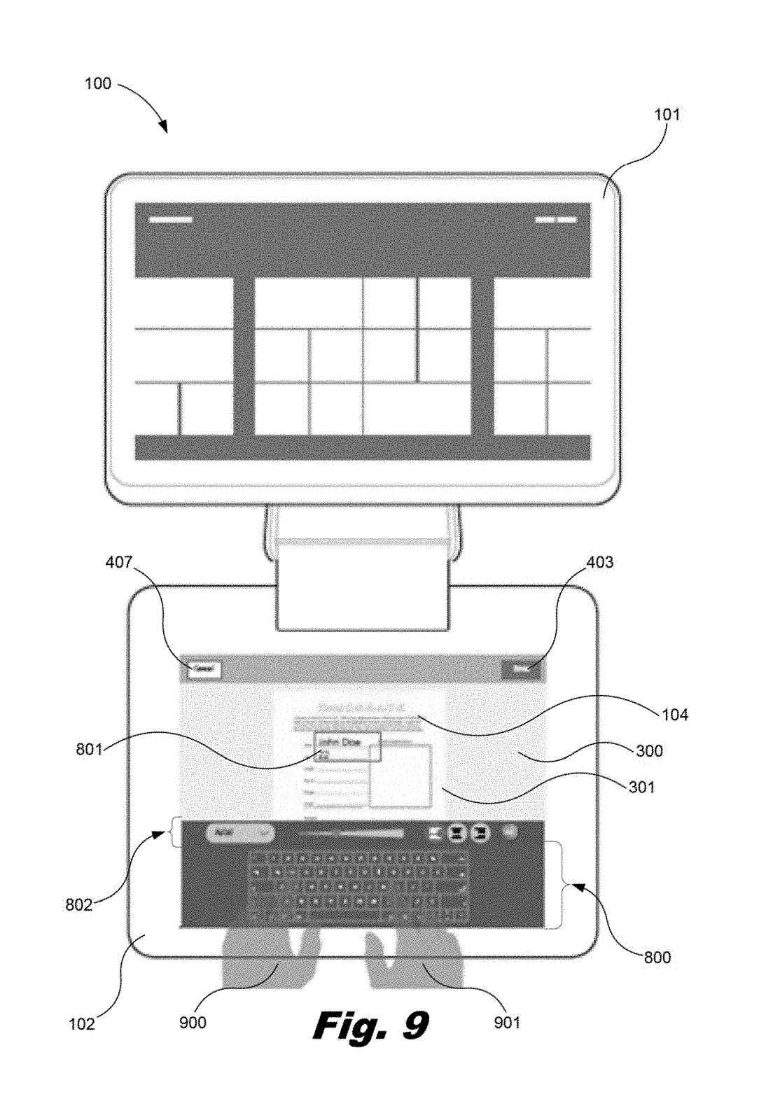

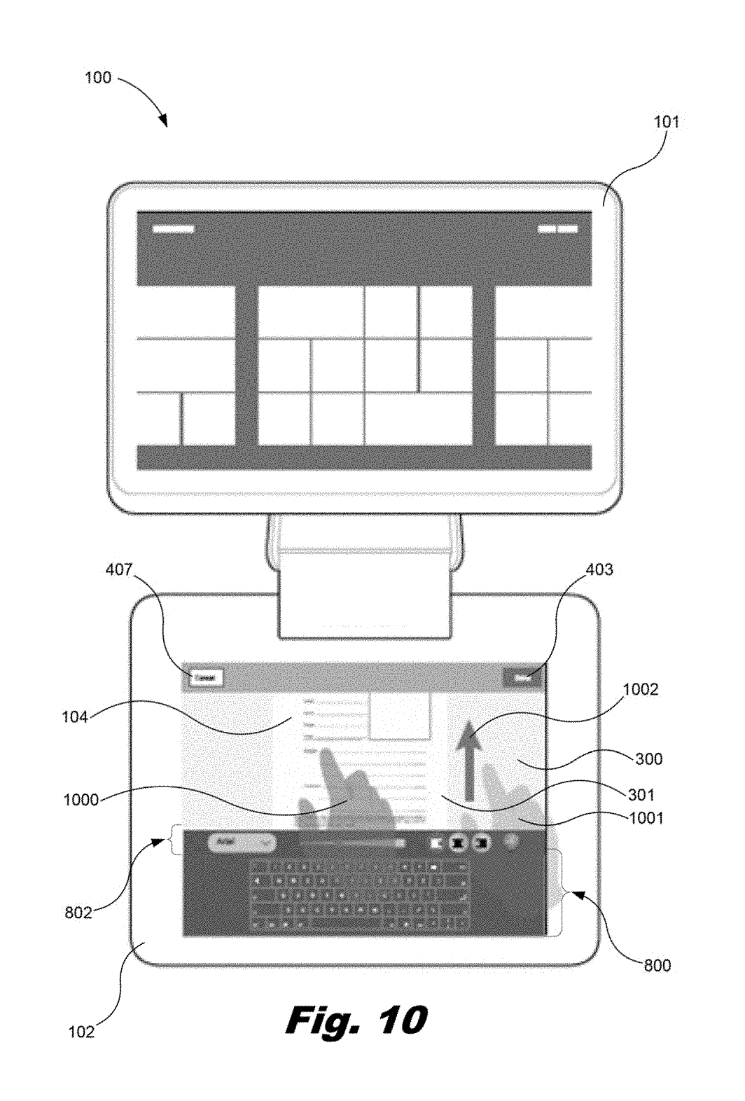

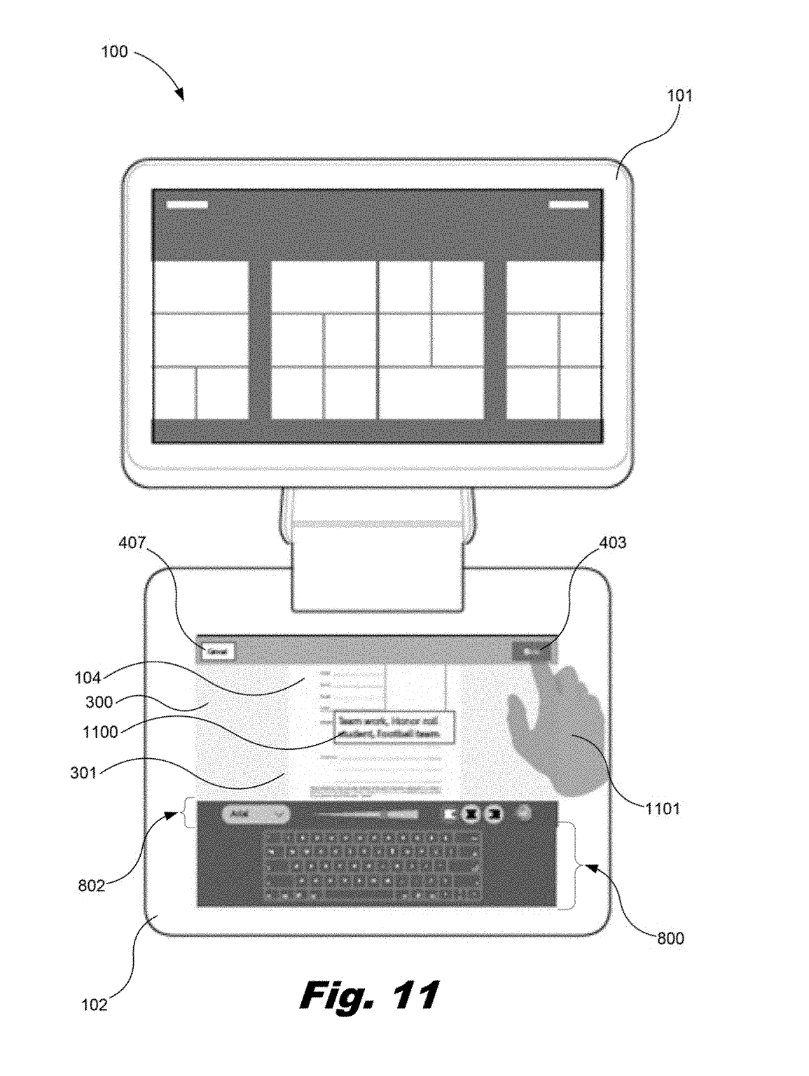

FIG. 9 shows a user typing as depicted by the ghost hands (900, 901). FIG. 10 depicts the user's ability to scroll to another portion of the document (104). In one example, the user may move his or her hand from the document (104) to a portion of the document display space (301) or the workspace (300) as depicted by ghost hands (1000, 1001), and drag on a portion of the document display, space (301) or the workspace (300) to scroll the document (104) up or down as depicted by arrow (1002). The user may tap on another portion of the document (104) in order to create a new text box (1100) as depicted in FIG. 11.

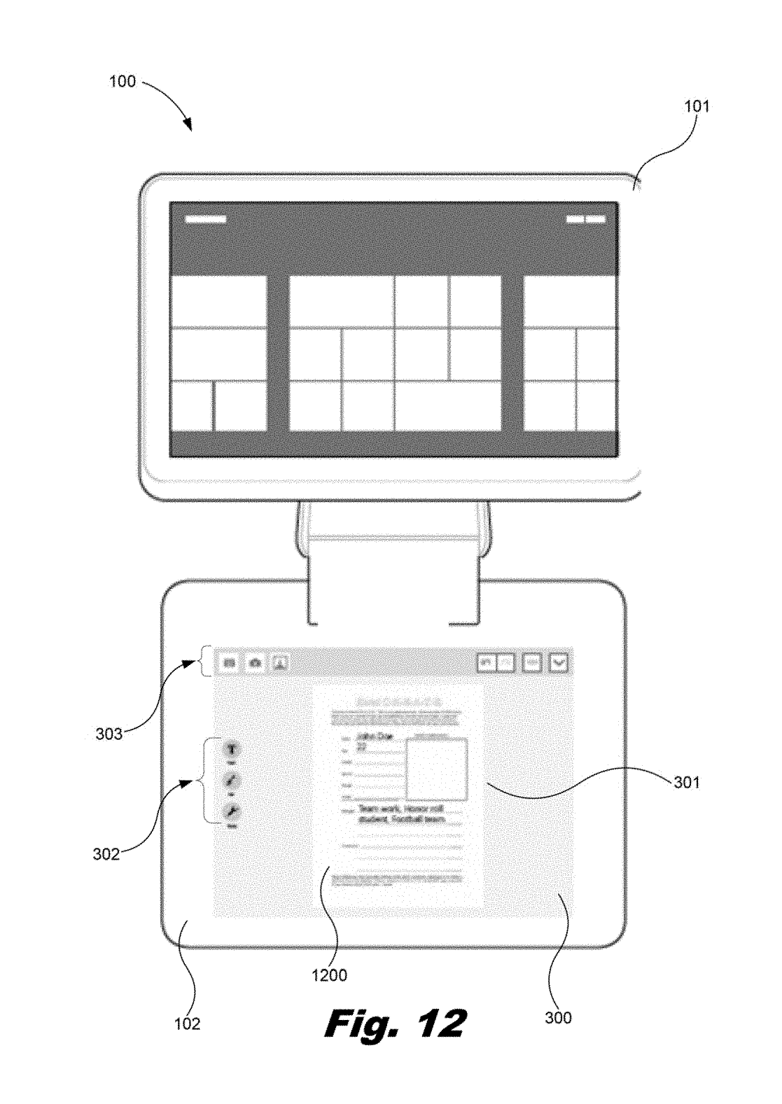

Once the user is finished annotating, the user may select a “Done” button (403) to exit the annotation mode as indicated by ghost hand (1101). Alternatively, in order to cancel the annotation and clear that text box (1100) or other text annotation instance from the document (104), and return to the document (104), the user may select a “Cancel” button (407). FIG. 12 depicts an annotated document (1200) on the document display space (301) of the workspace (300) displayed on the touch-sensitive pad (102). The annotations made to the document (104) in order to achieve a desired annotated document (1200) are implicitly grouped to one another and to the underlying document (104).

The user may further annotate the annotated document (1200), or may save a copy of the annotated document (1203). Stoning the annotated document may include indicating that the annotations are grouped on a common canvas. This implicit grouping allows for standard object types to be used and to move all of the grouped objects as a unit by moving the canvas containing all the annotations

In one example, the user may ungroup the implicit grouping of annotations. This may be performed by selecting one or more annotations via the touch-sensitive pad (102) or via the computing device (101) or the display device (209) of the computing device (101), arid selecting an ungroup option. This ungrouping option allows the user to select individual annotations for deletion, moving, rotation, or other form of editing.

The code contained business rules to determine when items should be automatically grouped versus treated as independent objects. For instance, when the user takes a digital photograph using the system's downward facing camera, the software will automatically enter an “isolation mode” that shows the photo taken by the user in the user interface all by itself. When in that contextually determined mode, the software allows the user to add ink and text objects that are implicitly grouped with the image.

The items are grouped by placing them on the same WPF canvas object, and the canvas object is then added to the collection of objects in the document. Since the canvas grouping mechanism is also used for manual or explicit user grouping of objects, the user can use the normal grouping controls to edit the group. Editing the group includes adding or removing objects from the group, ungrouping all of the objects, and repositioning grouped objects relative to each other.

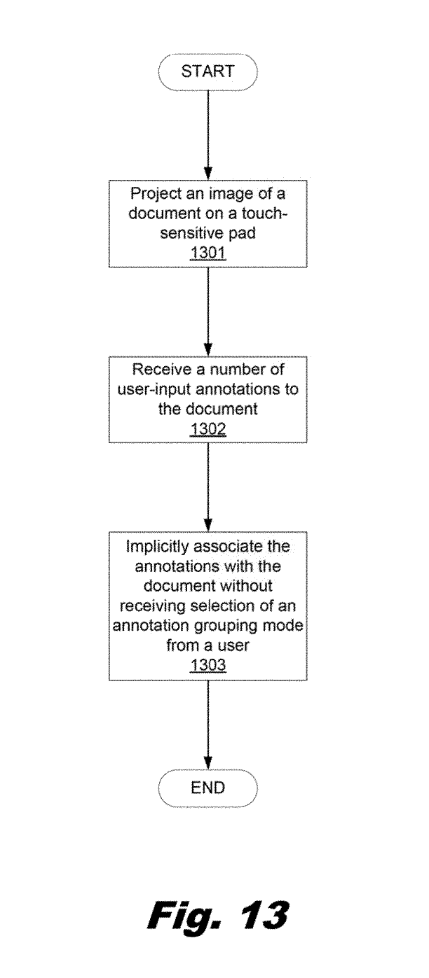

FIG. 13 is a flowchart showing a method (1300) of annotating, an image, according to one example of the principles described herein. The method (1300) may begin by projecting (block 1301) an image of a document onto a touch-sensitive pad (102). This may be performed by the imaging device (105) capturing an image of a document (104) and projecting the image onto the touch-sensitive pad (102) as described above. The system (100), executing the annotation module (230), may receive (block 1302) a number of user-input annotations to the document (104). The system (100), executing the annotation grouping module (240), implicitly associates the annotations with the document (104) without receiving selection of an annotation grouping mode from a user. An annotation grouping mode is any mode that causes the system (100) to group or ungroup annotations made to the document (104). In this example, the system (100), executing the annotation grouping module (240), implicitly associates the annotations with the document (104), and the user may then select a annotation grouping mode to override the implicit grouping.

Thus, the implicit grouping feature of the present systems and methods allows the user to implicitly group annotations within an annotated document by default while still allowing the user to specify a number explicit groupings of a number of selected objects. In either situation, the annotations are grouped together and treated like a single, compound object. The default behavior is beneficial because otherwise a user who wants to annotate a digital image using ink or text, for example, would need to perform the additional steps of explicitly grouping annotations with, the document (104). If the user does not perform this non-implicit step, then the annotations would not move with or be treated as a part of the document (104) when the user manipulates the document (104). The present systems and methods are more intuitive because they group the annotation with the document (104) implicitly.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (201) of the computer device (101) or other programmable data processing, apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a method, system, and computer program product for implicitly grouping annotations with a document. The method includes, with a projection device, projecting an image of a document onto a touch sensitive pad. The method further includes receiving a number of user-input annotations to the document, and with a processor, implicitly associating the annotations with the document without receiving selection of an annotation grouping mode from a user. This method of implicitly grouping annotations with a document may have a number of advantages, including: (1) allowing a user to reuse the previously implemented grouping, inking, and text editing features of the software application with minimal modification; (2) providing the user with a flexible annotation feature y allowing the user to freely choose to annotate an image with any number of annotations; and without utilizing a label or callout approach; and (3) through the context-based approach of the present systems and methods, allowing the software to default to treating text and ink as annotations when the context suggests this is the users intent while also allowing the user the ability to ungroup the text and ink into independent objects, among other advantages.

The preceding description has been presented to illustrate and describe examples of the principles described. This description is not intended to be exhaustive or to limit these principles to any precise form disclosed Many modifications and variations are possible in light of the above teaching.

What is claimed is:

1. A method of implicitly grouping annotations with a document, comprising:
with a projection device, projecting an image of a document onto a touch sensitive pad,
receiving a number of user-input annotations to the document; and
with a processor, implicitly associating the annotations with the document without receiving selection of an annotation grouping mode from a user.

2. The method of claim 1, further comprising:
capturing an image of the document with an image capturing device; and
with the processor, initiate an isolation mode in which the image of the document is displayed to a user on a display device.

3. The method of claim 2, in which the display device is a touch-sensitive pad on which the image of the document is projected.

4. The method of claim 2, in which the display device is a touch-screen computing device.

5. The method of claim 1, in which implicitly associating the annotations, with the document without receiving selection of an annotation mode from a user comprises:
grouping the annotations by adding the annotations to a common graphical user interface (GUI) layer; and
adding the GUI layer as one of a number of layers associated with the image of the document.

6. The method of claim 1, further comprising receiving user-specified association instructions, the user-specified association instructions defining how the annotation group is edited, in which the edited grouping is treated by the processor as compound object.

7. The method of claim 6, in which editing the annotation group comprises adding annotations to the annotation group, removing annotations from the annotation group, repositioning grouped annotations relative to each other, or combinations thereof.

8. A computer program product for implicitly grouping annotations with a document, the computer program product comprising:
a computer readable storage medium comprising computer usable program code embodied therewith, the computer usable program code
when executed by a processor, to detect user-input on a touch sensitive pad; and
implicitly associate the user-input as a number of annotations to an image of a document projected on the touch sensitive pad without receiving selection of an annotation mode from a user.

9. The computer program product of claim 8, further comprising:
computer usable program code to, when executed by a processor, determine if a captured image comprises a document; and
if the captured image is a document:
computer usable program code to, when executed by a processor, define a number of fields in the document; and
computer usable program code to, when executed by a processor, recognize a number of characters within the document using an optical character recognition process on the document.

10. The computer program product of claim 8, further comprising:
computer usable program code to, when executed by the processor, create a bounding box bounding the annotations; and
computer usable program code to, when executed by the processor, determine if a subsequently added annotation is outside the bounding box; and
if the subsequently added annotation is outside the bounding box:
computer usable program code to, when executed by the processor, increasing the size of the bounding box to include the subsequent annotation.

11. The computer program product of claim 8, further comprising computer usable program code to, when executed by the processor, determine whether annotations should be grouped or treated as independent annotations based on a number of policies.

12. The computer program product of claim 8, further comprising computer usable program code to, when executed by the processor, determine whether the user annotations are ink annotations, a text annotations, or imported digital objects.

13. The computer program product of claim 8, in which the image of the document is an image captured by an image capture device coupled to the processor.

14. A system for annotating document, comprising.
an image capture device for capturing an image of a document;
an image projection device for projecting the image of the document onto a touch-sensitive pad in the same location and orientation as the original document during the capturing of the image of the document;
a processor to receive a number of user-input annotations to the document and implicitly associate the annotations with the document without receiving a selection of an annotation mode from a user.

15. The system of claim 14, in which the image of the document is an image of a document prepared by a computer program.
